(19) United States
(12) Patent Application Publication
(10) Pub. No.: US 2026/0092467 A1
(43) Pub. Date: Apr. 2, 2026

(54) EXPANDABLE VEHICLE-MOUNTED TENT

(71) Applicant: Xiaoyao LUO, Bazhong (CN)

(72) Inventor: Xiaoyao LUO, Bazhong (CN)

(21) Appl. No.: 18/900,957

(22) Filed: Sep. 30, 2024

(51) Int. Cl. E04H 15/06; E04H 15/50; E06C 1/12

(52) U.S. Cl. CPC E04H 15/06; E04H 15/50; E06C 1/12

(57) ABSTRACT

An expandable vehicle-mounted tent includes a tent top cover and a drive assembly. The drive assembly includes a first fork bar and a second fork bar, an end of the first fork bar is connected to a bottom of the tent top cover, the other end of the first fork bar is provided with a first sliding block, and the other end of the first fork bar is slidably connected with the first sliding block. The expandable vehicle-mounted tent is easy to store and carry, and significantly reduces production cost.

### TECHNICAL FIELD

The disclosure relates to the technical filed of tents, and more particularly to an expandable vehicle-mounted tent.

### BACKGROUND

A car roof tent is a type of tent installed on the roof of a car, also known as a home on the roof of the car, which is convenient for increasing living space and has gradually become one of the optional equipment for outdoor self-driving tours.

At present, the more popular car roof tents on the market are triangular folding type and vertical lifting type, and these two types of the car roof tents are hard-top tents, composed of a top cover, a base board, and a tent fabric. The top cover is dragged upward to separate from the base board in a manual method, and the top cover and the base board are driven to completely separate with the help of a hydraulic rod, thereby unfolding the tent fabric and forming a tent space. However, the manual method is quite troublesome to unfold the top cover manually, and requires to climb onto the roof of the car with the help of a ladder, which is time-consuming and laborious.

A patent with a publication number CN111719933A discloses a car roof tent, which is equipped with a hydraulic lifting device between a top cover and a base board. The hydraulic lifting device is configured to drive the top cover to unfold or fold vertically relative to the base board, and this method is automated, saving time and effort. However, the applicant found in practical use that the hydraulic lifting device applies a scissor-fork type lifting mechanism, which is vertically hinged by multiple fork arms. Although an unfolding height of the top cover is increased, after the scissor-fork type lifting mechanism is folded, multiple fork arms are stacked in the vertical direction, resulting in a larger vertical space occupied by the scissor-fork type lifting mechanism between the top cover and the base board after they are folded. This leads to a larger thickness of the car roof tent, and consequently, a larger volume of the tent. The structure of the above patent is complex, the production cost is high, and it does not meet consumer demands.

### SUMMARY

The main purpose of the disclosure is to provide an expandable vehicle-mounted tent, which is highly practical, structurally simple, easy to store and carry, and significantly reduces production cost.

In order to achieve the aforementioned purpose, the disclosure provides an expandable vehicle-mounted tent, which includes a tent top cover, a tent base tray, a peripheral cloth and a drive assembly; the tent top cover is disposed above the tent base tray, the peripheral cloth surrounds the expandable vehicle-mounted tent, and the drive assembly is configured to drive the tent top cover to fold or unfold relative to the tent base tray to form an accommodating space.

A number of the drive assembly is at least one; each drive assembly includes a folding assembly and a telescopic rod, and each drive assembly is disposed within the accommodating space; the folding assembly includes a first fork bar and a second fork bar, and the first fork bar and the second fork bar are intersected and hinged with each other; an end of the first fork bar is connected to a bottom of the tent top cover, the other end of the first fork bar is provided with a first sliding block thereon, a side of the first sliding block defines a first sliding groove, and the other end of the first fork bar is slidably connected with the first sliding block along the first sliding groove; the second fork bar includes a first fork arm and a second fork arm, an end of the first fork arm is connected to the bottom of the tent top cover, the other end of the first fork arm is hinged with an end of the second fork arm, and the other end of the second fork arm is fixedly connected to the tent base tray.

The telescopic rod is disposed on a side of the first sliding block, an end of the telescopic rod is fixedly connected to the bottom of the tent top cover, and the other end of the telescopic rod is fixedly connected to the tent base tray.

In an embodiment, a first rotating shaft is disposed between the first fork bar and the second fork bar, and the first fork bar is hinged with the second fork bar through the first rotating shaft.

In an embodiment, a second rotating shaft is disposed between the first fork arm and the second fork arm, and the first fork arm is hinged with the second fork arm through the second rotating shaft.

In an embodiment, a first base is disposed on the other end of the second fork arm, and the other end of the second fork arm is fixedly connected to the tent base tray through the first base.

In an embodiment, the telescopic rod is a pneumatic telescopic rod.

In an embodiment, a second base disposed on the other end of the telescopic rod, and the telescopic rod is fixedly connected to the tent base tray through the second base.

In an embodiment, the number of the drive assembly is two, and the two drive assemblies are same in shape and size.

In an embodiment, an expandable sunshade fabric is disposed on the tent top cover, and a length of the expandable sunshade fabric is shorter than a distance between the tent top cover and the tent base tray.

In an embodiment, at least one support rod is disposed on the expandable sunshade fabric, and the expandable sunshade fabric is connected to the tent base tray through the at least one support rod.

In an embodiment, a telescopic ladder is disposed on the tent base tray.

In an embodiment, hanging rings are disposed on the tent base tray, a top of the telescopic ladder is disposed with hooks, and the telescopic ladder is connected to the tent base tray by hanging the hooks inside the hanging rings.

The beneficial effects of the disclosure are as follows: The expandable vehicle-mounted tent provided by the disclosure includes a tent top cover, a tent base tray, a peripheral cloth, and a drive assembly; a number of the drive assembly is at least one, each drive assembly is disposed within the accommodating space and includes a first fork bar and a second fork bar, and the first fork bar and the second fork bar are intersected and hinged with each other; an end of the first fork bar is connected to a bottom of the tent top cover, the other end of the first fork bar is provided with a first sliding block thereon, a side of the first sliding block defines a first sliding groove, and the first fork bar is slidably connected with the first sliding block along the first sliding groove; the second fork bar includes a first fork arm and a second fork arm, an end of the first fork arm is connected to the bottom of the tent top cover, the other end of the first fork arm is hinged with an end of the second fork arm, and the other end of the second fork arm is fixedly connected to the tent base tray. Each drive assembly also includes a first telescopic rod, which is disposed on a side of the first sliding block, an end of the telescopic rod is fixedly connected to the bottom of the tent top cover, and the other end of the telescopic rod is fixedly connected to the tent base tray.

Through the above structural configuration, the disclosure maximizes the accommodating space by crossing and hinging the first fork bar and the second fork bar and telescoping the telescopic rod back and forth; it also makes the expandable vehicle-mounted tent more convenient to store, more convenient to use, and more portable; the structure of the expandable vehicle-mounted tent provided by the disclosure is simple, which greatly reduces the production cost.

The expandable vehicle-mounted tent provided by the disclosure further includes a telescopic ladder, which is more convenient and has a better user experience when the expandable vehicle-mounted tent is used on the roof of a car; and the expandable vehicle-mounted tent provided by the disclosure is highly practical, safe, and reliable, suitable for widespread promotion and use.

### BRIEF DESCRIPTION OF DRAWINGS

In order to provide a clearer explanation of the embodiments of the disclosure or the technical solutions in the related art, a brief introduction will be given below to the accompanying drawings required in the description of the embodiments or the related art. It is apparent that the accompanying drawings in the following description are some of the embodiments of the disclosure. For those skilled in the art, other drawings can be obtained based on the structures shown in these drawings without creative labor.

FIG. 1 illustrates a schematic structural diagram of an expandable vehicle-mounted tent according to an embodiment of the disclosure.

FIG. 2 illustrates another schematic structural diagram of the expandable vehicle-mounted tent according to an embodiment of the disclosure.

FIG. 3 illustrates yet another schematic structural diagram of the expandable vehicle-mounted tent according to an embodiment of the disclosure.

FIG. 4 illustrates a schematic structural diagram of a drive assembly of the expandable vehicle-mounted tent according to an embodiment of the disclosure.

FIG. 5 illustrates a schematic diagram of a usage state of the expandable vehicle-mounted tent according to an embodiment of the disclosure.

FIG. 6 illustrates a schematic diagram of another usage state of the expandable vehicle-mounted tent according to an embodiment of the disclosure.

FIG. 7 illustrates a schematic diagram of a folded state of the expandable vehicle-mounted tent according to an embodiment of the disclosure.

The realization of the purpose, the functional features and the advantages of the disclosure will be further described with reference to the accompanying drawings in conjunction with the embodiments.

### DETAILED DESCRIPTION OF EMBODIMENTS

The following will provide a clear and complete description of the technical solution in embodiments of the disclosure, in conjunction with the accompanying drawings. Apparently, the described embodiments are only a part of the embodiments of the disclosure, not all of them. Based on the embodiments in the disclosure, all other embodiments obtained by those skilled in the art without creative labor fall within the scope of protection of the disclosure.

It should be noted that all directional indications (such as up, down, left, right, front, back, etc.) in the embodiments of the disclosure are used solely to explain the relative positions, movements, etc., of the components in a specific attitude (as shown in the accompanying drawings). If that specific attitude changes, the directional indications will correspondingly change as well.

In the disclosure, unless otherwise specifically defined and limited, terms such as “connected” and “fixed” should be broadly understood. For example, “fixed” can mean a rigid connection, a detachable connection, or being formed as one piece; it can be a mechanical connection or an electrical connection; it can be a direct connection or an indirect connection through an intermediary; it can be an internal connection within two components or an interactive relationship between two components, unless specifically limited. For those skilled in the art, the specific meaning of the aforementioned terms in the context of the disclosure can be understood based on the specific circumstances.

Additionally, if the embodiments of the disclosure involve descriptions such as “first”, “second”, etc., these descriptions of “first”, “second”, etc., are used solely for descriptive purposes and should not be understood as indicating or implying their relative importance or implicitly specifying the number of the technical features they refer to. Therefore, features specified as “first”, “second”, etc., can explicitly or implicitly include at least one of such features. Furthermore, the term “and/or” used throughout the text encompasses three concurrent options; for example, “A and/or B” includes options for A only, B only, or both A and B together. Additionally, the technical solutions in different embodiments can be combined with each other, provided that such combinations are achievable by those skilled in the art. When a combination of technical solutions results in contradictions or is unfeasible, such the combination is considered non-existent and is not within the scope of protection claimed by the disclosure.

The disclosure provides an expandable vehicle-mounted tent.

### Embodiment 1

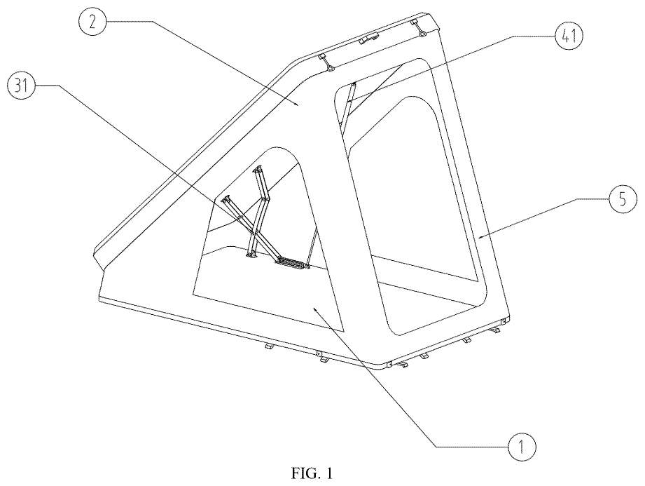

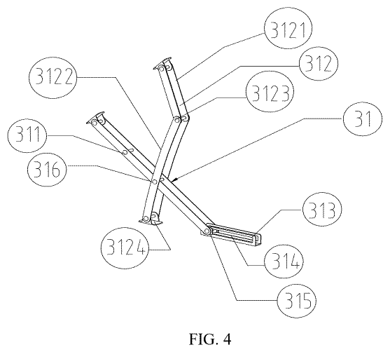

Referring to FIGS. 1-4, in an embodiment of the disclosure, the expandable vehicle-mounted tent includes a tent body 100, which includes a tent top cover 2, a tent base tray 1, a peripheral cloth 5 and a drive assembly. The tent top cover 2 is disposed above the tent base tray 1, and the peripheral cloth 5 surrounds the expandable vehicle-mounted tent. Preferably, the peripheral cloth 5 includes a first window 8 and a second window 9, which are respectively disposed on two sides of the tent.

The drive assembly is configured to drive the tent top cover 2 to fold or unfold relative to the tent base tray 1 to form an accommodating space; preferably, the peripheral cloth 5 is disposed between the tent top cover 2 and the tent base tray 1.

Referring to FIGS. 1-4, a number of the drive assembly is at least one; preferably, in the embodiment, each drive assembly includes a first folding assembly and a first telescopic rod 41; each drive assembly is disposed within the accommodating space; the first folding assembly includes a first fork bar 311 and a second fork bar 312.

The first fork 311 bar and the second fork bar 312 are intersected and hinged with each other; an end of the first fork bar 311 is connected to a bottom of the tent top cover 2, the other end of the first fork bar 311 is provided a first sliding block 313 thereon, a side of the first sliding block defines a first sliding groove 314, and the other end of the first fork bar 311 is slidably connected with the first sliding block 313 along the first sliding groove 314; the second fork bar 312 includes a first fork arm 3121 and a second fork arm 3122, an end of the first fork arm 3121 is connected to the bottom of the tent top cover 2, the other end of the first fork arm 3121 is hinged with an end of the second fork arm 3122, and the other end of the second fork arm 3122 is fixedly connected to the tent base tray 1.

The first telescopic rod 41 is disposed on a side of the first sliding block 313, an end of the first telescopic rod 41 is fixedly connected to the bottom of the tent top cover 2, and the other end of the first telescopic rod 41 is fixedly connected to the tent base tray 1.

In the embodiment, preferably, a first rotating shaft 316 is disposed between the first fork bar 311 and the second fork bar 312, and the first fork bar 311 is hinged with the second fork bar 312 through the first rotating shaft 316.

In the embodiment, preferably, a second rotating shaft 3123 is disposed between the first fork arm 3121 and the second fork arm 3122, and the first fork arm 3121 is hinged with the second fork arm 3122 through the second rotating shaft 3123.

In the embodiment, preferably, a first base 3124 is disposed on the other end of the second fork arm 3122, and the other end of the second fork arm 3122 is fixedly connected to the tent base tray 1 through the first base 3124, making the first drive assembly 31 more stable and secure to use.

In the embodiment, preferably, the first telescopic rod 41 is a first pneumatic telescopic rod.

In the embodiment, further preferably, a second base 411 is disposed on the other end of the first telescopic rod 41, and the first telescopic rod 41 is fixedly connected to the tent base tray 1 through the second base 411, making the first telescopic rod 41 more stable, safe, and reliable to use.

In the embodiment, further preferably, a first sliding plate 315 is disposed on the first sliding groove 314 on the side of the first sliding block 313, and the other end of the first fork bar 311 is slidably connected to the first sliding block 313 along the first sliding groove 314 through the first sliding plate 315; disposing the first sliding plate 315 on the first sliding groove 314 not only helps protect the other end of the first fork bar 311 and extends its service life, but also makes the sliding of the first fork bar 311 in the first sliding groove 314 smoother.

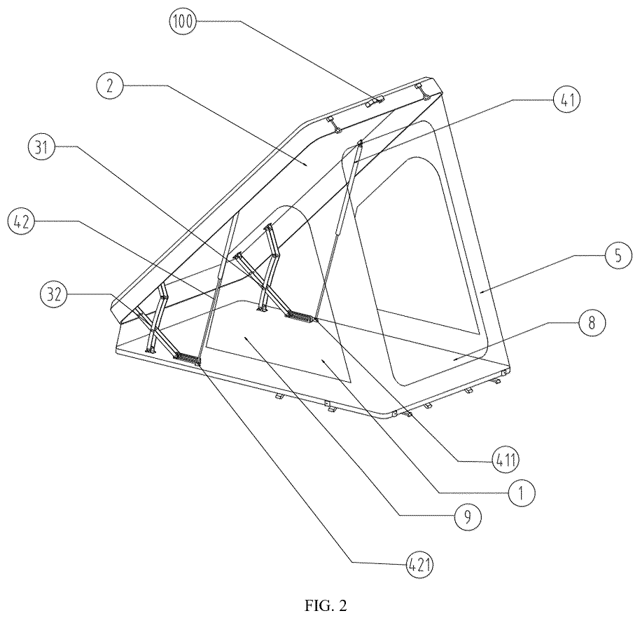

Referring to FIG. 2, in the embodiment, preferably, the drive assembly includes a first drive assembly 31 and a second drive assembly 32, and the first drive assembly 31 and the second drive assembly 32 are same in shape, structure and size.

Further preferably, the second drive assembly 32 includes a second folding assembly and a second telescopic rod 42; the second folding assembly and the first folding assembly are same in shape, size and structure.

In the embodiment, further preferably, the second telescopic rod 42 and the first telescopic rod 41 are same in shape, structure and size.

A third base 421 is disposed on a bottom of the second telescopic rod 42, and the second telescopic rod 42 is fixedly connected to the tent base tray 1 through the third base 421.

The first drive assembly 31 and the second drive assembly 32 are respectively disposed on two side of the accommodating space of the disclosure, which makes the tent provided by the disclosure more convenient to fold or unfold, simpler to use and operate, and provides better user experience.

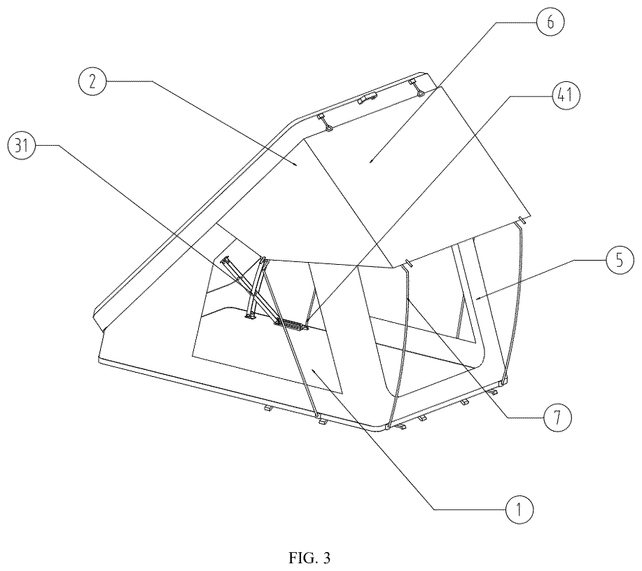

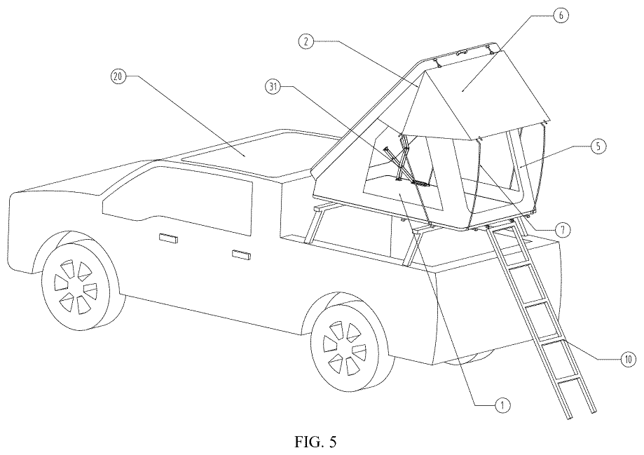

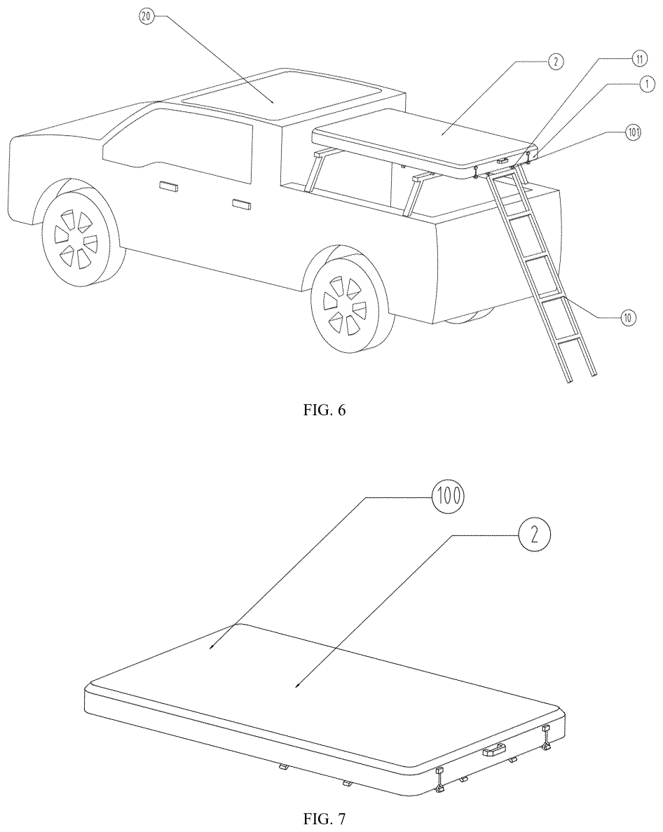

Referring to FIGS. 3, 5, 6, and 7, in the embodiment, preferably, an expandable sunshade fabric 6 is disposed on the tent top cover 2, and a length of the expandable sunshade fabric 6 is shorter than a distance between the tent top cover 2 and the tent base tray 1. The expandable sunshade fabric 6 serves to provide shade, block light, protect against wind, and shield from rain.

In the embodiment, further preferably, at least one first support rod 7 is disposed on the expandable sunshade fabric 6, and the expandable sunshade fabric 6 is fixedly connected to the tent base tray 1 through the first support rod 7, which makes the use of the expandable sunshade fabric 6 more stable and reliable.

In the embodiment, further preferably, two support rods are disposed on the expandable sunshade fabric 6, and the expandable sunshade fabric 6 is fixedly connected to the tent base tray 1 through the two support rods, which makes the use of the expandable sunshade fabric 6 safer and more reliable.

In the embodiment, preferably, a telescopic ladder 10 is disposed on the tent base tray 1.

In the embodiment, further preferably, hanging rings 11 are disposed on the tent base tray 1, a top of the telescopic ladder 10 is disposed with hooks 101, and the telescopic ladder 10 is connected to the tent base tray 1 by hanging the hooks 101 inside the hanging rings 11.

When the vehicle-mounted tent is in use, the tent body 100 of the vehicle-mounted tent is disposed on a roof of a car 20. When the tent body 100 is unfolded on the roof, the tent base tray 1 supports the telescopic ladder 10, the telescopic ladder 10 is placed on a side of the car to facilitate people getting in and out of the car 20. When people need to rest in the tent body 100, they can enter the tent body 100 through the first window 8 using the telescopic ladder 10, making it more convenient to use.

The disclosure is highly practical, has a simple structure, is more convenient and safer to use, reliable, and at the same time significantly reduces production cost, making it easy to store and carry.

The above description is merely an optional embodiment of the disclosure and does not limit the patent scope of the disclosure. Any equivalent structural modifications made under the inventive concept of the disclosure using the content of the specification and drawings, or direct/indirect applications in other related technical fields are included within the patent protection scope of the disclosure.

What is claimed is:

1. An expandable vehicle-mounted tent, comprising: a tent top cover, a tent base tray, a peripheral cloth and a drive assembly; wherein the tent top cover is disposed above the tent base tray, the peripheral cloth surrounds the expandable vehicle-mounted tent, and the drive assembly is configured to drive the tent top cover to fold or unfold relative to the tent base tray to form an accommodating space;
wherein a number of the drive assembly is at least one; each drive assembly comprises a folding assembly and a telescopic rod, and each drive assembly is disposed within the accommodating space; the folding assembly comprises a first fork bar and a second fork bar, and the first fork bar and the second fork bar are intersected and hinged with each other; an end of the first fork bar is connected to a bottom of the tent top cover, the other end of the first fork bar is provided with a first sliding block thereon, a side of the first sliding block defines a first sliding groove, and the other end of the first fork bar is slidably connected with the first sliding block along the first sliding groove; the second fork bar comprises a first fork arm and a second fork arm, an end of the first fork arm is connected to the bottom of the tent top cover, the other end of the first fork arm is hinged with an end of the second fork arm, and the other end of the second fork arm is fixedly connected to the tent base tray; and
wherein the telescopic rod is disposed on a side of the first sliding block, an end of the telescopic rod is fixedly connected to the bottom of the tent top cover, and the other end of the telescopic rod is fixedly connected to the tent base tray.

2. The expandable vehicle-mounted tent as claimed in claim 1, wherein a first rotating shaft is disposed between the first fork bar and the second fork bar, and the first fork bar is hinged with the second fork bar through the first rotating shaft.

3. The expandable vehicle-mounted tent as claimed in claim 2, wherein a second rotating shaft is disposed between the first fork arm and the second fork arm, and the first fork arm is hinged with the second fork arm through the second rotating shaft.

4. The expandable vehicle-mounted tent as claimed in claim 3, wherein a first base is disposed on the other end of the second fork arm, and the other end of the second fork arm is fixedly connected to the tent base tray through the first base.

5. The expandable vehicle-mounted tent as claimed in claim 4, wherein the telescopic rod is a pneumatic telescopic rod.

6. The expandable vehicle-mounted tent as claimed in claim 5, wherein a second base is disposed on the other end of the telescopic rod, and the telescopic rod is fixedly connected to the tent base tray through the second base.

7. The expandable vehicle-mounted tent as claimed in claim 6, wherein the number of the drive assembly is two, and the two drive assemblies are same in shape and size.

8. The expandable vehicle-mounted tent as claimed in claim 7, wherein an expandable sunshade fabric is disposed on the tent top cover, and a length of the expandable sunshade fabric is shorter than a distance between the tent top cover and the tent base tray.

9. The expandable vehicle-mounted tent as claimed in claim 8, wherein at least one support rod is disposed on the expandable sunshade fabric, and the expandable sunshade fabric is connected to the tent base tray through the at least one support rod.

10. The expandable vehicle-mounted tent as claimed in claim 9, wherein a telescopic ladder is disposed on the tent base tray.

11. The expandable vehicle-mounted tent as claimed in claim 10, wherein hanging rings are disposed on the tent base tray, a top of the telescopic ladder is disposed with hooks, and the telescopic ladder is connected to the tent base tray by hanging the hooks inside the hanging rings.
